(19) United States
(12) Patent Application Publication
(10) Pub. No.: US 2008/0196463 A1
(43) Pub. Date: Aug. 21, 2008

(54) Precursor coatings for sulfur coated controlled release fertilizers

(76) Inventors: Alice P. Hudson, Jupiter, FL (US); James E. Nevin, Lake Worth, FL (US)

Correspondence Address: Alice P. Hudson, 1303 Park Lane South, Jupiter, FL, 33458, US

(21) Appl. No.: 11/708,756

(22) Filed: Feb. 21, 2007

(51) Int. Cl. C05C 9/00; C05F 11/00; C05G 1/00

(52) U.S. Cl. 71/28; 71/1; 71/11; 71/27

(57) ABSTRACT

A controlled release sulfur coated fertilizer with improved abrasion resistance is produced by applying a precursor coating that forms a cohesive film which adheres to the fertilizer substrate particles and to the sulfur that is subsequently applied in molten form. The improved fertilizer also optionally comprises a sealant coating applied after the molten sulfur. This invention is to the composition of the fertilizer and the method of production.

### FIELD OF THE INVENTION

This invention relates to coating materials and methods of application which provide improved abrasion resistance and controlled release properties to sulfur coated fertilizers including sulfur coated urea.

### BACKGROUND OF THE INVENTION

The process of sulfur coating fertilizer particles was developed in 1968 by the Tennessee Valley Authority (TVA) as an economical system for reducing the dissolution rate of urea particles applied to the soil as fertilizer. U.S. Pat. No. 3,342,577 describes the sulfur coating process which includes an optional first coating of a material selected from the group comprising petrolatums, petroleum softwaxes, petroleum oils, wood rosins, paraffins, and mixtures thereof; the sulfur coating; and a sealant material that is required to fill in the cracks and holes occurring in the sulfur coating as it is cooled and processed. The sulfur coating process and the requirement for a sealant for sulfur coated urea (SCU) has been documented by McClellan and Scheib (Sulphur Inst. J. 9(3/4) 8-12 (1973) and by Scheib and McClellan ibid. 12(1) 2-5 (1976). A further component described as a conditioning agent is often applied as a surface dressing to prevent the cooled sealant coated particles from adhering to each other in storage.

One of the purposes of the sealant is to reduce the effects of abrasion on the release characteristics of the sulfur coated granules or prills. Improving abrasion resistance means reducing the difference between abraded and unabraded release rates of nutrients from the fertilizer particles into the medium onto or into which the fertilizer is applied. Abrasion is the term used in the fertilizer industry to describe the effect on the fertilizer of handling, transporting and applying the product after it is produced. Abrasion effects are cumulative and can result in much higher dissolution rates at the retail level compared to freshly manufactured product. Marketers must therefore increase the amount of SCU in their blends to assure that the product performance complies with the labeling for controlled release content. Higher than designed release rates of nutrients can also cause damage to the vegetation to which it is applied. U.S. Pat. Nos. 5,300,135 and 5,984,994 describe the application and use of improved abrasion resistant sealants for SCU. These sealants contain wax bases that are mixed with wax soluble polymers for increased adhesive strength and durability.

In addition to the use of wax based sealants as a coating over the sulfur layer polymer coatings have also been used. U.S. Pat. No. 5,599,374 describes the use of a polyurethane polymer coating formed in situ on the surface of the sulfur-coated urea granule for the purpose of improving the abrasion resistance of the composite coated granule.

Another variation of the sulfur coating process is described in U.S. Pat. No. 4,857,098 which describes the process of applying molten fertilizer and molten sulfur simultaneously to the surface of the granule followed by application of the molten sulfur alone thus enabling the sulfur layer to be tightly bound to the fertilizer granules.

U.S. Pat. No. 3,576,613 describes the use of a finely divided powdered material on the surface of the fertilizer particles prior to the application of molten sulfur. The powder coating reduces the contact angle of the molten sulfur on the fertilizer surface allowing it to spread more evenly and improve the controlled release properties of the coated particles.

U.S. Pat. No. 6,388,746 describes a thermoset polymer coated fertilizer to which a molten sulfur layer is applied, followed by another thermoset polymer layer.

When sulfur coated fertilizer particles with a sealant coating prepared by methods of the prior art are subjected to abrasion in laboratory tests or in the field, and then examined under a microscope, it is observed that the bond between the fertilizer particle and the sulfur coating often fails, and this is believed to be a major factor in the decreased controlled release properties of these products after abrasion. The use of the improved wax or polymer sealant compositions of the prior art, while providing some benefit, does not provide the improved bonding of the sulfur to the fertilizer surface necessary to the integrity of the particle.

To improve the abrasion resistance of sulfur coated fertilizers manufacturers may apply a thicker sulfur coating. While this improves the abrasion resistance the increased coating weight decreases the nutrient analysis of the coated fertilizer, and can also lead to a “lock-off” of nutrient release, in which a significant fraction of the fertilizer nutrients do not release at all.

It is an object of this invention to improve the abrasion resistance of sulfur coated fertilizer particles by the addition of an adhesive precursor coating to the fertilizer particle to improve the bond between the fertilizer surface and the sulfur coating.

A further object of this invention is to increase the nutrient content of the coated fertilizer by reducing the overall coating requirement necessary to achieve the same abraded release rate compared to SCU or other sulfur coated fertilizer particles prepared by previously known methods.

Another object of this invention is to improve the performance and integrity of the overall coating by improving the adhesion of the sulfur coating to the substrate fertilizer particle by the provision of a precursor adhesive coating on the substrate.

### SUMMARY OF THE INVENTION

It has now been discovered that coating fertilizer particles, including urea prills or granules, with a precursor coating of an adhesive coupling material herein described, and then overcoating with molten sulfur, optionally followed by an application of a sealant material, produces a sulfur coated fertilizer product that has superior abrasion resistance and improved overall release characteristics.

Primer or precursor materials that can be effectively used in this application are substances with film forming properties that will adhere to the fertilizer substrate and form a cohesive coating layer to which the applied sulfur also adheres. The preferred precursor materials are polymers, copolymers and mixture thereof which can be applied as a molten material, or as an aqueous suspension of small particles, or as a solution in a solvent; which form an adhered and cohesive film on the surface of the fertilizer granule; and adhere to the sulfur that is subsequently applied. Suitable precursor materials also include resinous materials such as rosin esters, tall oil pitch and asphalt.

This invention is also to the process of forming sulfur coated fertilizer compositions with improved abrasion resistance and release characteristics. The process consists of 1) the addition of a precursor coating to the fertilizer particles, followed by 2) the addition of molten sulfur, and 3) optionally, the addition of a sealant coating.

### DESCRIPTIONS OF THE PREFERRED EMBODIMENTS

Abrasion resistant controlled release fertilizer compositions comprise a central core of a particulate plant nutrient, coated with an adhesive coupling agent or precursor coating, subsequently coated with molten sulfur, and then optionally coated with a sealant material.

The fertilizer substrate can be any fertilizer particles to which it is desired to add a sulfur coating to provide controlled release properties and/or provide elemental sulfur as a nutrient. Sulfur coated urea is produced commercially in large volumes and the urea substrates used for this production are highly suitable. The urea substrate particles are produced by a number of processes including falling curtain granulation, fluid bed granulation, and prilling; and urea from any process is suitable. Other suitable substrates include potassium sulfate and ammonium sulfate granules, potassium chloride granules, and ammonium nitrate granules or prills. Any particulate water soluble plant nutrient to which it may be desirable to apply a sulfur coating is within the scope of this invention.

The adhesive coupling agent or precursor coating materials are chosen from cohesive film forming materials which adhere to the fertilizer substrate and to which the molten sulfur also adheres.

For the purposes of this invention, “film forming” is defined as the ability of a material to form a substantially continuous film by any applicable method, including but not limited to the coalescence of polymer latex particles on drying, the removal of solvent from a dissolved polymer or the solidification of a molten liquid thermoplastic material on cooling.

“Adhesion” is defined herein as the ability of a material applied to the surface of a substrate to resist separation. The nature of the bonding that creates the adhesion can be any effective chemical or physical interaction and the invention is not limited by the type of bonding that occurs. A laboratory test was devised to determine adhesion characteristics of potential precursor coatings on both a urea substrate and a sulfur coating layer. The test consisted of forming a urea surface by pouring molten urea melted at 140° C. into an aluminum cylinder 1 inch long and 1 inch inside diameter. After cooling to ambient temperature the surface was ground and polished to a smooth surface flush with the rim of the cylinder, and the candidate adhesive material was applied by spraying a solution, latex emulsion, or molten material to the desired coating weight. The coated urea sample was placed in a convection oven at about 60° C. for 5 minutes until all volatile components had been removed from the coating. When the coating was dry a second identical cylinder was placed on top of the first, held in place mechanically, and filled with molten sulfur heated to about 130° C. The cylinders were then allowed to cool for several hours. The adhesive or bond strength of the bonded urea-sulfur interface was measured by placing the assembly in a rigid fixture and measuring the shearing force required to separate the two cylinders at the interface. The force was applied by a rod attached to a pneumatic cylinder equipped with a pressure gage. Force was steadily increased until the cylinders separated at the interface, at which point the pressure on the gage was recorded, and defined as the “break point”. The results shown in the table in Example 1 are the average break points of three identically prepared samples.

The precursor coatings can be any materials that are film forming and adhesive as defined above. Suitable materials are preferably polymeric, and can be chemically reactive or nonreactive with the fertilizer substrate and the sulfur coating. Crosslinking polymers, either self-crosslinking or crosslinked with an added catalyst, are suitable. The coating materials are preferably nonflowing non-tacky flexible solids at ambient conditions in their dry or cured state, are preferably water insoluble, and also preferably contain polar groups which improve the adhesion to the fertilizer substrate and sulfur. The preferred precursor materials are polymers, copolymers and mixture thereof which can be applied as a molten material, or as an aqueous dispersion of small particles, or dissolved in a solvent. Other additives, including but not limited to coalescing aids, crosslinking agents, fillers, pigments, extenders, diluents and solvents necessary to achieve the desired physical and chemical properties for this application may be added.

Suitable precursor materials also include resinous materials such as rosin esters, tall oil pitch and asphalt. These are less preferred because they typically require the use of non-aqueous solvents to facilitate their application, which may contribute to health, safety, and environmental hazards in their application. Also, resinous materials tend to remain undesirably tacky when the solvent has evaporated.

The preferred precursor coatings of this invention are polymer and copolymer latexes formed by emulsion polymerization and supplied as stable very small particle suspensions. These polymers are commonly used, for example, as binders in coatings and adhesives. More preferred polymers and copolymers have glass transition temperatures, T_{g}, from about 0° C. to 35° C. Polymers with T_{g} lower than about 0° C. tend to remain tacky at ambient conditions after drying and curing, and polymers with T_{g} higher than about 35° C. tend to be insufficiently pliable to protect the sulfur coated particle from the effects of abrasion. The polymers and copolymers listed and described below are suitable materials. Mixtures of polymers are also suitable. One skilled in the art will recognize that this list is representative only; other polymers with film forming and adhesion properties suitable for this application are available and are within the scope of this invention.

i. Vinyl acetate polymers and copolymers. Examples of these materials include
Rovace™ vinyl acetate homopolymers and acrylate copolymers available from Rohm & Haas Company, Philadelphia, Pa. Rovace 6930 is self crosslinking.
Vinac™ vinyl acetate homopolymers available from Air Products Corporation, Allentown, Pa.
Airflex™ vinyl acetate copolymers with ethylene or vinyl chloride, available from Air Products Corporation. Some of these products are self crosslinking.
Flexbond™ vinyl acetate copolymers with acrylate esters, available from Air Products Corporation.
   ii. Acrylic ester polymers and copolymers. Examples of these materials include
Acronal Optive™ acrylic polymers and copolymers with styrene, available from BASF Corporation, Florham Park, N.J., Acronal Optive 410 is a self crosslinking styrene copolymer.
Acronal™ acrylate polymers and copolymers with styrene or acrylonitrile, available from BASF Corporation. The Acronals may contain carboxylate groups to improve adhesion, and may be self crosslinking
Rhoplex™ acrylic polymers, available from Rohm and Haas Corporation
Flexcryl™ acrylic polymers, available from Air Products Corporation
Texicryl™ acrylic copolymers with styrene or acrylonitrile, available from Scott Bader Inc., Stow, Ohio. The Texicryls may contain carboxylate groups to improve adhesion.
   iii. Styrene acrylic copolymers. Examples of these materials include
Texicryl™ styrene acrylic copolymers, available from Scott Bader Inc. The Texicryls may be self crosslinkable, Texicryl 13-060, 13-061 and 13-065 have silane incorporated into the backbone to improve flexibility and water resistance.
   iv. Styrene-butadiene copolymers. Examples of these materials include
Butofan™ butadiene-styrene copolymers, available from BASF Corporation. The Butofan copolymers are less preferred, as they contain a major portion of butadiene monomer, have very low T_{g} values and form tacky films.
Styronal™ styrene-butadiene copolymers, available from BASF Corporation. The Styronal polymers generally form non-tacky films, and may be carboxylated to improve adhesion.
Styrofan™ styrene-butadiene copolymers, available from BASF Corporation. The Styrofan copolymers may be self crosslinking, and may contain carboxylate groups to improve adhesion.
Butonal™ styrene-butadiene copolymers, available from BASF Corporation. Butonal polymers are non carboxylated and rubbery.
   v. Vinylidene chloride polymers and copolymers. Examples of these materials include:
Polidene™ vinylidene chloride acrylate copolymers, available from Scott Bader Inc. Polidene AD9044 is a methyl acrylate copolymer.
   vi. Vinyl ether polymers and copolymers. Examples of these materials include:
Lutanol™ vinyl ether polymers, available from BASF Corporation. These polymers are supplied as solvent solutions and are less preferred in this application.

The adhesive precursor coatings are applied to the fertilizer substrates at levels from about 0.1 weight % to 10 weight % active precursor material on the weight of fertilizer substrate and precursor material, and preferably at levels from about 0.2 weight % to 2 weight %. They can be sprayed, or applied in a thin stream, or applied in portions onto the fertilizer substrate particles in a suitable coating device, from suspensions or solutions containing from about 10 to 50% by weight active coating material with sufficiently low viscosity to spread on the fertilizer particles in the coating device. The coating process is preferably carried out at temperatures from ambient to about 80° C. The water or other solvent contained in the polymer suspensions or solution can be removed by evaporation, either by providing ventilation in the coating device, or in a separate drying step in a fluid bed dryer or other suitable equipment. The application procedure substantially uniformly coats the fertilizer particles with the precursor coating and dries and/or cures the applied coating to a cohesive film. The invention is not limited by the method of accomplishing this result.

The sulfur coating process is described in the publication “TVA's Development of Sulfur-Coated Urea” (August 1974) incorporated herein by reference. Sulfur is applied at levels from about 5 weight % to 30 weight % of the fertilizer substrate and coating materials, and preferably at levels between about 10 and 20 weight %. Typically the sulfur is melted at about 125-140° C. and sprayed in small droplets on a falling curtain of fertilizer particles, which have been preheated to about 50 to 80° C. The compositions and application of the precursor coating of this invention can be used in any sulfur coating process, and the invention is not limited by the method of applying the sulfur coating.

In most applications it is desirable to apply a sealant coating after the sulfur coating process. The optional sealant can be any material that has historically been used or proposed for application on sulfur coated fertilizers. Examples include petroleum waxes, mixtures of polyethylene and brightstock oil, and sealant compositions described in U.S. Pat. Nos. 5,300,135, 5,423,897, 5,478,375, and 5,984,994, incorporated herein by reference. The sealants can be applied at levels from about 0.2 weight % to about 10 weight % of the coated particles, and are preferably applied at levels from about 1 weight % to about 5 weight %. Other materials which may provide the function of sealing cracks and imperfections in the sulfur coating are suitable, and this invention is not limited by the composition of or method of applying the sealant coating.

This invention is also directed to the process of manufacturing abrasion resistant controlled release fertilizer compositions in which a central core of a particulate plant nutrient is coated with an adhesive coupling agent or precursor coating, subsequently coated with molten sulfur, and finally optionally coated with a sealant material, as described supra.

The following examples further illustrate the invention. As used herein all parts or percentages are by weight of the entire composition unless otherwise indicated.

### EXAMPLE 1

The adhesion test described above was used to evaluate potential precursor coatings. The results are shown in Table 1.

TABLE 1

| | | Wt. | Break |
|---|---|---|---|
| | | applied | Point |
| Precursor agent | Solvent | (g) | (psi) |
| None | None | 0 | 0 |
| Polysulfide (1) | acetone | 0.022 | 17 |
| Vinyl acetate acrylic copolymer latex (2) | Water | 0.042 | 41 |
| Acrylic polymer latex (3) | Water | 0.021 | 55+ |
| Polyacrylic acid copolymer latex (4) | Water | 0.020 | 55+ |
| Polyacrylic acid (5) | Water | 0.058 | 34 |
| Sulfonated polystyrene (6) | Water | 0.024 | 15 |
| Rosin ester (7) | Ethyl acetate | 0.025 | 55+ |
| Styrene Butadiene copolymer latex (8) | Water | 0.054 | 55+ |
| Styrene Maleic anhydride copolymer (9) | Acetone | 0.022 | 1 |
| Dithiobisphthalimide | Pyridine | 0.013 | 12 |

(1) LP-33 from Morton Thiocol,
(2) Rovace HP-3442 from Rohm & Haas,
(3) Rhoplex AC-1024 from Rohm & Haas,
(4) Alcogum L-31 from Alco Chemical,
(5) Aquatreat AR-900A from Alco Chemical,
(6) Versa TL-501 from National Starch,
(7) NovaRez 1182 from Georgia Pacific,
(8) DL-240 from Dow Reichhold Specialty Latex LLC,
(9) SMA-1000A from Sartomer.

The urea-sulfur interface with no precursor coating did not have measurable adhesive strength. The preferred latex polymers provided excellent adhesive strength. The water soluble polyacrylic acid and sulfonated polystyrene provided adhesion, but did not provide adequate controlled release in subsequent testing. The rosin ester provided excellent adhesion but required application from a solvent solution. The styrene maleic anhydride resin has a very high T_{g} of 155° C. and provided inadequate adhesion. The monomeric dithiobisphthalimide provided limited adhesion.

A coating device consisting of the following components was used to apply precursor coatings, sulfur and sealant.
1. An 18-inch diameter by 4 inch wide stainless steel drum, heated with hot air.
2. An inner liner constructed of polycarbonate and consisting of 14 equally spaced 1-inch tall lifting flights mounted at 11 vertical degrees running the width of the drum.
3. A base mount two roller drive equipped with a variable speed controller capable of driving the drum at speeds up to 10 revolutions per minute.
4. A stainless steel air atomizing nozzle with heat control.
5. An internally heated air line with PID temperature control.
6. An internally heated sulfur line with PID temperature control.
7. A heated sulfur pot with PID temperature control.

### EXAMPLE 2 (COMPARATIVE)

1000 g of granular urea with an average particle diameter of 2 millimeters was charged to the coating drum. The urea was heated to a temperature of 60° C. while the drum rotated at 4 revolutions per minute. When the drum and its contents reached 60° C. the drum speed was increased until a curtain of urea formed in front of the nozzle, and molten sulfur at 140° C. was applied via the air atomizing nozzle. When approximately 150 g of sulfur had been applied to the urea the sulfur application was discontinued and 275 g of the sulfur coated urea was removed from the drum and transferred to a second coating apparatus where 2% by weight of a wax sealant was applied. After the sealant application the coated particles were cooled with gentle agitation to less than 40° C. The resulting coated fertilizer is a product that is similar to the sulfur coated urea of commerce.

The process was continued by spraying 36 g additional molten sulfur onto the remaining 875 g of sulfur coated product in the coating drum. After the sulfur addition, 300 g was discharged and coated with 2% wax sealant as described previously.

The process was continued by spraying 18 g additional molten sulfur onto the remaining 611 g of sulfur coated product in the coating drum. After the sulfur addition, 300 g was discharged and coated with 2% wax sealant as described previously.

### EXAMPLE 3

1000 g of granular urea with an average particle size of 2 millimeters was charged to the coating drum. The urea was heated to a temperature of 60° C. while the drum rotated at 4 revolutions per minute. When the drum and its contents reached 60° C. the drum speed was increased to a speed just below that necessary to form a falling curtain. A 50% active silane modified styrene acrylic copolymer latex (TEXICRYL® 13-060 from Scott Bader, Inc.) was added dropwise to the urea until a total weight of 10 g had been added. The drum rotation and temperature was maintained until the product had dried. The drum speed was increased to form a falling curtain and the sulfur was sprayed until approximately 150 g had been applied. The product was transferred to a second coating apparatus where a wax sealant was applied at 2% coating weight.

### EXAMPLE: 4

A sulfur coated urea was prepared using the same materials, equipment and methods as in Example 3 except that 13 g of the Styrene acrylic copolymer latex was added to the urea to form the precursor coating.

### EXAMPLE 5

1000 g of granular urea with an average particle size of 2 millimeters was charged to the coating drum. The urea was heated to a temperature of 60° C. while the drum rotated at 4 revolutions per minute. When the drum and its contents reached 60° C. the drum speed was increased to a speed just below that necessary to form a falling curtain. A 50% silane modified styrene acrylic copolymer latex (TEXICRYL® 13-061 from Scott Bader, Inc.) was added dropwise to the urea until a total weight of 7 g had been added. The drum rotation and temperature was maintained until the product had dried. The drum speed was increased to form a falling curtain and the sulfur was sprayed until approximately 130 g had been applied. 300 g of the coated urea was transferred to a second coating apparatus where a wax sealant was applied at 2% coating weight.

The process was continued by spraying 17 g additional molten sulfur onto the remaining 830 g of sulfur coated product in the coating drum. After the sulfur addition, 300 g was discharged and coated with 2% wax sealant as described previously.

### EXAMPLE 6

Using the same equipment and methods as in Example 3 a self crosslinking vinyl acetate acrylic latex (Rovace 6930 from Rohm and Haas Company) was added to the granular urea at 9 g per 1000 g of urea. After the water had evaporated from the film, the coated urea was sprayed with molten sulfur as previously described until a total of 150 g had been applied. The product was transferred to another apparatus where a wax sealant was applied at 2% coating weight.

### EXAMPLE 7

Using the same equipment and methods as in Example 3 a Vinylidene chloride copolymer latex (Polidene 33-004 from Scott Bader) was applied to the granular urea at 10 g per 1000 g of urea. After the water had evaporated from the film, the coated urea was sprayed with molten sulfur as previously described until a total of 150 g had been applied. The product was transferred to another apparatus where a wax sealant was applied at a 2% coating weight.

### EXAMPLE 8

Using the same equipment and methods as in Example 3 an acrylic copolymer latex (Texicryl 13-500 from Scott Bader Inc.) was applied to the granular urea at 15 g per 1000 g of urea. After the water had evaporated from the film, the coated urea was sprayed with molten sulfur as previously described until a total of 290 g had been applied. The product was transferred to another apparatus where a wax sealant was applied at a 2% coating weight.

### EXAMPLE 9

Using the same equipment and methods as in Example 3 an acrylic copolymer latex (Optiva 410 from BASF) was applied to the granular urea at 10 g per 1000 g of urea. After the water had evaporated from the film 150 g of sulfur was applied followed by a 2% wax sealant.

### EXAMPLE 10

Using the same equipment and methods as in Example 3, a self crosslinking styrene acrylic copolymer latex (Texicryl 13-061 from Scott Bader, Inc.) was applied to the granular urea at 11 g per 1000 g of urea. After the water had evaporated from the film, 87 g of sulfur was applied and 300 g of coated product was removed from the drum and coated with 2% wax sealant. 26 g of molten sulfur was applied to the 777 g of coated product in the drum, and the coated product was discharged and coated with 2% sealant.

### EXAMPLE 11

Using a different coating drum with dimensions of 18 inches diameter and 10 inches in width with the same flight design as in the drum described in Example 2, a self crosslinking styrene acrylic copolymer latex (Texicryl 13-065 from Scott Bader, Inc.) was applied dropwise at a level of 26 g to 2500 g of granular urea. When the precursor film had fully cured sulfur was applied as previously described until a total of 463 g had been applied. The product was transferred to a second apparatus where a wax sealant was applied at a 2% coating weight.

The products prepared in Examples 2 through 10 were evaluated for abrasion resistance by the following laboratory procedure. A 50 g sample of the coated product was dropped to impact a stainless steel surface through a PVC pipe 6 feet in height and 4 inches in diameter. The material was collected and the drop was repeated to a total of 5 drops. The release characteristics of the sample were determined by placing 40 g of the abraded product into 200 g of water in a closed container, and storing the mixture at 38° C. for 7 days. A sample of the coated product that had not been abraded was set up in the same manner. After 7 days the mixtures were gently agitated until the water phase was uniform and the refractive index of the water phase was determined. The refractive index relates linearly to the concentration of urea in solution, and amount of urea in solution was compared to amount of urea originally in the coated particles. The results of these tests are shown in Table 2.

TABLE 2

| | Precursor | | | | % release | % release | |
|---|---|---|---|---|---|---|---|
| Example | Coating | % applied | % Sulfur | % Sealant | not abraded | abraded | Difference |
| 2 | None | — | 13 | 2 | 39 | 55 | 16 |
| 2 | | | 16 | 2 | 29 | 47 | 18 |
| 2 | | | 19 | 2 | 11 | 25 | 14 |
| 3 | Styrene-acrylic | 1.0 | 14 | 2 | 23 | 29 | 6 |
| 4 | Styrene-acrylic | 1.3 | 14 | 2 | 21 | 29 | 8 |
| 5 | Styrene-acrylic | 0.7 | 11 | 2 | 40 | 50 | 10 |
| 5 | Styrene-acrylic | 0.7 | 13 | 2 | 26 | 29 | 3 |
| 6 | Vinyl acetate- | 1.0 | 13 | 2 | 12 | 22 | 10 |
| | acrylic | | | | | | |
| 7 | Vinylidene chloride | 1.0 | 13 | 2 | 11 | 18 | 7 |
| | copolymer | | | | | | |
| 8 | Acrylic copolymer | 1.5 | 23 | 2 | 6 | 16 | 10 |
| 9 | Acrylic copolymer | 1.0 | 13 | 2 | 20 | 27 | 7 |
| 10 | Styrene-acrylic | 1.0 | 8 | 2 | 41 | 54 | 13 |
| | ″ | 1.0 | 11 | 2 | 19 | 32 | 13 |
| 11 | Styrene-acrylic | 1.0 | 16 | 2 | 10 | 20 | 10 |

### EXAMPLE 12

50 g of sulfur coated urea products with 2% sealant applied were subjected to abrasion using the method described in Example 11, and the amount of coating material that abraded from the particle surfaces as dust was measured after 5, 10, and 20 cycles of abrasion. The results are shown in Table 3. The addition of the precursor coatings substantially reduces the coating material that is lost on abrasion.

TABLE 3

| | | | g of coating dust | | |
|---|---|---|---|---|---|
| Precursor | % | % Sulfur | 5 cycles | 10 cycles | 20 cycles |
| None | | 11 | 0.018 | 0.037 | 0.104 |
| None | | 16 | 0.016 | 0.024 | 0.047 |
| Texicryl 13-060 | 1.0 | 14 | 0.013 | 0.015 | 0.018 |
| Texicyrl 13-060 | 0.9 | 15 | 0.009 | 0.012 | 0.017 |
| Acronal Optive 410 | 1.0 | 13 | 0.013 | 0.016 | 0.018 |

The invention can be embodied in other forms without departing from the spirit or essential attributes thereof. Reference should therefore be had to the following claims, rather than to the foregoing specification to determine the scope of the invention.

1. An abrasion resistant controlled release fertilizer comprising
(a) a central core of a particulate plant nutrient, surrounded by
(b) a coating of an adhesive coupling agent chosen from the group consisting of film forming materials that form adhesive bonds with the particulate plant nutrient to which it is applied and the sulfur coating layer subsequently applied,
(c) a sulfur coating, and
(d) optionally, a sealant material.

2. The composition of claim 1 wherein the adhesive coupling agent is polymeric.

3. The composition of claim 2 wherein the polymeric adhesive coupling agent is applied in the form of one or more latex polymers.

4. The composition of claim 1 wherein the adhesive coupling agent is applied at a weight of from about 0.1 to 10% of the total composition.

5. The composition of claim 1 wherein the adhesive coupling agent is applied at a weight of from about 0.2 to 2% of the total composition.

6. The composition of claim 3 wherein the latex polymers are chosen from the group consisting of vinyl acetate polymers and copolymers, acrylic ester polymers and copolymers, styrene acrylic copolymers, styrene-butadiene copolymers, and vinylidene chloride polymers and copolymers.

7. The composition of claim 3 wherein the polymeric adhesive coupling agent has a glass transition temperature T_{g} from about 0° C. to 35° C.

8. The composition of claim 1 wherein the adhesive coupling agent is applied at a weight from about 0.1% to 10%, the sulfur is applied at a weight from about 5 to 30%, and the sealant is applied at a weight from about 0.2 to 10% of the total fertilizer composition.

9. The composition of claim 1 wherein the particulate plant nutrient is urea.

10. The composition of claim 1 wherein the particulate plant nutrient is ammonium sulfate.

11. The composition of claim 9 wherein the defined break point of the urea sulfur adhesive bond is greater that about 10 pounds per square inch.

12. An abrasion resistant controlled release fertilizer comprising
(a) a central core of a particulate plant nutrient, surrounded by
(b) a coating of an adhesive coupling agent chosen from the group consisting of film forming materials that form adhesive bonds with the particulate plant nutrient to which it is applied and the sulfur coating layer subsequently applied, and
(c) a sulfur coating.

13. The method of making an abrasion resistant controlled release fertilizer consisting essentially of
(a) providing a quantity of particulate water soluble plant nutrient,
(b) applying a coating of an adhesive coupling agent chosen from the group consisting of film forming materials which form adhesive bonds with the fertilizer substrate to which it is applied and the sulfur coating subsequently applied to the plant nutrient particles,
(c) applying a sulfur coating to the coated particles by spraying with molten sulfur; and
(d) optionally, applying a sealant material to the sulfur coated particles.

14. An abrasion resistant controlled release fertilizer prepared by the method of claim 13.
